(19) United States
(12) Patent Application Publication
(10) Pub. No.: US 2007/0103720 A1
(43) Pub. Date: May 10, 2007

(54) Image generating apparatus

(75) Inventor: Hideo Kobayashi, Daito-shi (JP)

Correspondence Address: CROWELL & MORING LLP;INTELLECTUAL PROPERTY GROUP, P.O. BOX 14300, WASHINGTON, DC, 20044-4300, US

(73) Assignee: Funai Electric Co., Ltd., Daito-shi (JP)

(21) Appl. No.: 11/515,953

(22) Filed: Sep. 6, 2006

(30) Foreign Application Priority Data
Nov. 8, 2005 (JP) 2005-322987

(51) Int. Cl. G06F 3/12

(52) U.S. Cl. 358/1.15

(57) ABSTRACT

An image generating apparatus capable of infrared communication over a wide range regardless of a beam spread angle of an infrared communication element is obtained. This image generating apparatus comprises a rotating member horizontally rotatably set on the upper surface of an apparatus body performing printing and an infrared communication portion mounted on the rotating member for infrared communication of image data.

### BACKGROUND OF THE INVENTION

1. Field of the Invention

The present invention relates to an image generating apparatus, and more particularly, it relates to an image generating apparatus comprising an infrared communication portion set on an apparatus body performing printing for infrared communication of image data.

2. Description of the Background Art

An image generating apparatus such as a thermal transfer printer comprising an infrared communication portion (infrared communication element) set on an apparatus body performing printing for infrared communication of image data is known in general. Further, a portable telephone having a camera portion and an infrared communication portion (infrared communication element) capable of transmitting image data (photographic data) picked up with the camera portion to a thermal transfer printer is also known in general. FIG. 12 is a perspective view showing an exemplary conventional thermal transfer printer and a portable telephone 110 having a camera portion 110a and an infrared communication element 110b. FIGS. 13 and 14 are sectional views showing communication between the conventional thermal transfer printer and the portable telephone 110 shown in FIG. 12 respectively. The structures of the exemplary conventional thermal transfer printer and the portable telephone 110 having the camera portion 110a and the infrared communication element 110b are now described with reference to FIGS. 12 to 14.

The exemplary thermal transfer printer has a printer body 101 capable of performing printing on the basis of image data, a paper feed tray 102 detachably mounted on the printer body 101 and an infrared communication element 103 for infrared communication of image data between the thermal transfer printer and the portable telephone 110, as shown in FIG. 12. The printer body 101 includes a receiving hole 110a for receiving an ink sheet cartridge (not shown), an infrared communication hole 101b for exposing the surface of the infrared communication element 103 and a mounting portion 101c for mounting the infrared communication element 103 on the printer body 101, as shown in FIGS. 12 and 13. The portable telephone 110 has the camera portion 110a capable of picking up images and the infrared communication element 110b for transmitting data of the images picked up with the camera portion 110a to the thermal transfer printer.

The infrared communication elements 103 and 110b of the printer body 101 of the thermal transfer printer and the portable telephone 110b correspond to the Ir-DA standard. The Ir-DA standard is an infrared communication standard set for allowing communication between products of various makers in infrared data communication. According to the Ir-DA standard, the beam spread angle is narrowed to ±15° on both transmission and receiving sides, in order to suppress interference between different apparatuses.

Data communication between the printer body 101 of the exemplary thermal transfer printer and the portable telephone 110 is now described. As shown in FIG. 13, the portable telephone 110 converts data of images picked up with the camera portion 110a to an infrared signal, so that the infrared communication element 110b transmits this signal. The transmitted infrared signal rectilinearly progresses at the beam spread angle of ±15°, and is received by the infrared communication element 103 of the printer body 101 of the thermal transfer printer. The thermal transfer printer converts the infrared signal received by the infrared communication element 103 to image data. The printer body 101 performs printing on the basis of the image data. The printer body 101 can also communicate with the portable telephone 110, as shown in FIG. 14.

In the conventional thermal transfer printer shown in FIGS. 12 to 14, however, it is difficult to communicate with the portable telephone 110 when the position or the direction of the infrared communication element 110b of the portable telephone 110 deviates from the infrared communication element 103 of the printer body 101 of the thermal transfer printer as shown in FIGS. 15 and 16, due to the narrow beam spread angle of ±15° according to the Ir-DA standard.

In this regard, a structure of an infrared communication module (infrared communication element) whose beam spread angle can be widened up to ±60° is proposed in general, as disclosed in Japanese Patent Laying-Open No. 11-288336 (1999), for example.

In the infrared communication module (infrared communication element) proposed in the aforementioned Japanese Patent Laying-Open No. 11-288336, a small mirror portion rotatable about X- and Y-axes serving as rotation centers is provided in front of a light-emitting diode and a photosensor, for allowing communication in the range of a cone having an apical angle of ±60° by rotating the small mirror portion by ±30° about the X- and Y-axes serving as rotation centers respectively.

According to the structure of the conventional infrared communication module disclosed in the aforementioned Japanese Patent Laying-Open No. 11-288336, however, no infrared communication is performable out of the range of the cone having the apical angle of ±60° serving as the beam spread angle although infrared communication is possible in the range of the cone having the apical angle of ±60° serving as the beam spread angle.

### SUMMARY OF THE INVENTION

The present invention has been proposed in order to solve the aforementioned problems, and an object of the present invention is to provide an image generating apparatus capable of infrared communication over a wide range regardless of a beam spread angle of an infrared communication element.

An image generating apparatus according to a first aspect of the present invention comprises a rotating member horizontally rotatably set on the upper surface of an apparatus body performing printing and an infrared communication portion mounted on the rotating member for infrared communication of image data.

As hereinabove described, the image generating apparatus according to the first aspect of the present invention so comprises the rotating member horizontally rotatably set on the upper surface of the apparatus body performing printing and the infrared communication portion mounted on the rotating member for infrared communication of image data that the infrared communication portion of the apparatus body can be rotated to a position opposite to an apparatus transmitting an infrared signal corresponding to the image data by horizontally rotating the infrared communication portion of the apparatus body on the upper surface of the apparatus body along with the rotating member when the position of the apparatus transmitting the infrared signal corresponding to the image data horizontally deviates from the infrared communication portion of the apparatus body. Thus, the image generating apparatus, capable of receiving the infrared signal from the apparatus transmitting the infrared signal corresponding to the image data also when the position of the apparatus transmitting the infrared signal corresponding to the image data horizontally deviates from the infrared communication portion of the apparatus body, can perform communication of the image data between the same and the apparatus transmitting the infrared signal corresponding to the image data. Consequently, the image generating apparatus can perform infrared communication over a wide range regardless of the beam spread angle of the infrared communication portion of the apparatus body.

In the aforementioned image generating apparatus according to the first aspect, the apparatus body preferably includes a recess portion provided on an upper portion of the apparatus body circularly in plan view, the rotating member preferably includes a cylindrical portion having a circular shape substantially identical in size to the recess portion of the apparatus body in plan view, and the recess portion of the apparatus body preferably stores the cylindrical portion of the rotating member. According to this structure, the image generating apparatus, capable of rotating the rotating member while bringing the cylindrical portion thereof into surface contact with the recess portion of the apparatus body, can suppress backlash when horizontally rotating the rotating member on the apparatus body.

In the aforementioned image generating apparatus according to the first aspect, the infrared communication portion is preferably vertically rotatably mounted on the rotating member. According to this structure, the image generating apparatus can rotate the infrared communication portion of the apparatus body to the position opposite to the apparatus transmitting the infrared signal corresponding to the image data by vertically rotating the infrared communication portion of the apparatus body when the position of the apparatus transmitting the infrared signal corresponding to the image data vertically deviates from the infrared communication portion of the apparatus body. Thus, the image generating apparatus, capable of receiving the infrared signal from the apparatus transmitting the infrared signal corresponding to the image data also when the position of the apparatus transmitting the infrared signal corresponding to the image data vertically deviates from the infrared communication portion of the apparatus body, can perform communication of the image data between the same and the apparatus transmitting the infrared signal corresponding to the image data. Consequently, the image generating apparatus can perform infrared communication over a wider range regardless of the beam spread angle of the infrared communication portion of the apparatus body.

In this case, the rotating member preferably further includes an infrared communication portion mounting portion mounted with the infrared communication portion in addition to the cylindrical portion, and the infrared communication portion mounting portion is preferably inclined at a prescribed angle with respect to the extensional direction of the cylindrical portion of the rotating member. According to this structure, the image generating apparatus can move the infrared communication portion of the apparatus body to the position opposite to the apparatus transmitting the infrared signal corresponding to the image data by rotating the infrared communication portion of the apparatus body toward the uppermost side also when the apparatus transmitting the infrared signal corresponding to the image data is located immediately above the apparatus body. Thus, the infrared communication portion of the apparatus body can receive the infrared signal from the apparatus, located immediately above the apparatus body, transmitting the infrared signal corresponding to the image data, whereby the image generating apparatus can perform infrared communication over a wider range.

In the aforementioned structure having the infrared communication portion vertically rotatably mounted on the rotating member, the infrared communication portion preferably includes a rotating portion vertically rotatably mounted on the rotating member and an infrared communication element mounted on the rotating portion. According to this structure, the image generating apparatus can easily vertically move the infrared communication portion by vertically rotating the rotating portion.

In this case, the rotating portion of the infrared communication portion is preferably in the form of a column. According to this structure, the image generating apparatus can easily rotate the rotating portion mounted with the infrared communication element in the infrared communication portion mounting portion.

In the aforementioned structure having the infrared communication portion including the rotating portion and the infrared communication element, the rotating portion is preferably provided on the surface thereof with a corrugated grip portion touched by an operator for digitally rotating the rotating portion. According to this structure, the operator can easily vertically move the infrared communication portion by digitally rotating the corrugated grip portion.

In this case, the grip portion is preferably provided in the vicinity of each side end surface of the rotating portion. According to this structure, the operator can easily vertically move the infrared communication portion by digitally touching the grip portion closer to him/her.

In the aforementioned image generating apparatus according to the first aspect, the infrared communication portion of the apparatus body is preferably capable of receiving an infrared signal corresponding to image data from an apparatus having a camera function and an infrared communication function of transmitting the infrared signal corresponding to the image data picked up through the camera function. According to this structure, the image generating apparatus can easily fetch the infrared signal corresponding to the image data picked up through the camera function of the apparatus into the apparatus body through the infrared communication portion thereof.

In the aforementioned image generating apparatus according to the first aspect, the infrared communication portion of the apparatus body is preferably so formed as to perform infrared communication employing the Ir-DA standard having a prescribed beam spread angle. Also when employing the Ir-DA standard with an extremely small beam spread angle of ±15°, for example, the image generating apparatus according to the present invention can perform infrared communication over a wide range regardless of the beam spread angle.

An image generating apparatus according to a second aspect of the present invention comprises an infrared communication portion set on an apparatus body performing printing for infrared communication of image data and a rotating member horizontally rotatably set on the upper surface of the apparatus body performing printing, while the infrared communication portion of the apparatus body includes a rotating portion vertically rotatably mounted on the rotating member and an infrared communication element mounted on the rotating portion and is capable of receiving an infrared signal corresponding to image data from an apparatus having a camera function and an infrared communication function of transmitting the infrared signal corresponding to the image data picked up through the camera function, and the rotating portion is provided on the surface thereof with a corrugated grip portion touched by an operator for digitally rotating the rotating portion.

As hereinabove described, the image generating apparatus according to the second aspect of the present invention so comprises the rotating member horizontally rotatably set on the upper surface of the apparatus body performing printing and the infrared communication portion mounted on the rotating member for infrared communication of image data that the infrared communication portion of the apparatus body can be rotated to a position opposite to the apparatus transmitting the infrared signal corresponding to the image data by horizontally rotating the infrared communication portion of the apparatus body on the upper surface of the apparatus body along with the rotating member when the position of the apparatus transmitting the infrared signal corresponding to the image data horizontally deviates from the infrared communication portion of the apparatus body. Thus, the image generating apparatus, capable of receiving the infrared signal from the apparatus transmitting the infrared signal corresponding to the image data also when the position of the apparatus transmitting the infrared signal corresponding to the image data horizontally deviates from the infrared communication portion of the apparatus body, can perform communication of the image data between the same and the apparatus transmitting the infrared signal corresponding to the image data. Consequently, the image generating apparatus can perform infrared communication over a wide range regardless of the beam spread angle of the infrared communication portion of the apparatus body. Further, the infrared communication portion is so vertically rotatably mounted on the rotating member that the image generating apparatus can rotate the infrared communication portion of the apparatus body to the position opposite to the apparatus transmitting the infrared signal corresponding to the image data by vertically rotating the infrared communication portion of the apparatus body when the position of the apparatus transmitting the infrared signal corresponding to the image data vertically deviates from the infrared communication portion of the apparatus body. Thus, the image generating apparatus, capable of receiving the infrared signal from the apparatus transmitting the infrared signal corresponding to the image data also when the position of the apparatus transmitting the infrared signal corresponding to the image data vertically deviates from the infrared communication portion of the apparatus body, can perform communication of the image data between the same and the apparatus transmitting the infrared signal corresponding to the image data. Consequently, the image generating apparatus can perform infrared communication over a wider range regardless of the beam spread angle of the infrared communication portion of the apparatus body.

According to the second embodiment, further, the infrared communication portion so includes the rotating portion vertically rotatably mounted on the rotating member and the infrared communication element mounted on the rotating portion that the image generating apparatus can easily vertically move the infrared communication portion by vertically rotating the rotating portion. In addition, the infrared communication portion of the apparatus body is enabled to receive the infrared signal corresponding to the image data from the apparatus having the camera function and the infrared communication function of transmitting the infrared signal corresponding to the image data picked up through the camera function, whereby the image generating apparatus can easily fetch the infrared signal corresponding to the image data picked up through the camera function of the apparatus into the apparatus body through the infrared communication portion thereof. Further, the rotating portion is provided on the surface thereof with the corrugated grip portion touched by the operator for digitally rotating the rotating portion, whereby the operator can easily vertically move the infrared communication portion by digitally rotating the corrugated grip portion.

In the aforementioned image generating apparatus according to the second aspect, the apparatus body preferably includes a recess portion provided on an upper portion of the apparatus body circularly in plan view, the rotating member preferably includes a cylindrical portion having a circular shape substantially identical in size to the recess portion of the apparatus body in plan view, and the recess portion of the apparatus body preferably stores the cylindrical portion of the rotating member. According to this structure, the image generating apparatus, capable of rotating the rotating member while bringing the cylindrical portion thereof into surface contact with the recess portion of the apparatus body, can suppress backlash when horizontally rotating the rotating member on the apparatus body.

In the aforementioned image generating apparatus according to the second aspect, the rotating member preferably further includes an infrared communication portion mounting portion mounted with the infrared communication portion in addition to the cylindrical portion, and the infrared communication portion mounting portion is preferably inclined at a prescribed angle with respect to the extensional direction of the cylindrical portion of the rotating member. According to this structure, the image generating apparatus can move the infrared communication portion of the apparatus body to the position opposite to the apparatus transmitting the infrared signal corresponding to the image data by rotating the infrared communication portion of the apparatus body toward the uppermost side also when the apparatus transmitting the infrared signal corresponding to the image data is located immediately above the apparatus body. Thus, the infrared communication portion of the apparatus body can receive the infrared signal from the apparatus, located immediately above the apparatus body, transmitting the infrared signal corresponding to the image data, whereby the image generating apparatus can perform infrared communication over a wider range.

In the aforementioned image generating apparatus according to the second aspect, the rotating portion of the infrared communication portion is preferably in the form of a column. According to this structure, the image generating apparatus can easily rotate the rotating portion mounted with the infrared communication element in the infrared communication portion mounting portion.

In the aforementioned image generating apparatus according to the second aspect, the grip portion is preferably provided in the vicinity of each side end surface of the rotating portion. According to this structure, the operator can easily vertically move the infrared communication portion by digitally touching the grip portion closer to him/her.

In the aforementioned image generating apparatus according to the second aspect, the infrared communication portion of the apparatus body is preferably so formed as to perform infrared communication employing the Ir-DA standard having a prescribed beam spread angle. Also when employing the Ir-DA standard with an extremely small beam spread angle of ±15°, for example, the image generating apparatus according to the present invention can perform infrared communication over a wide range regardless of the beam spread angle.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a perspective view showing a thermal transfer printer according to an embodiment of the present invention and a portable telephone having a camera portion and an infrared communication element;

FIG. 2 is an exploded perspective view showing the thermal transfer printer according to the embodiment shown in FIG. 1;

FIG. 3 is a side elevational view showing the thermal transfer printer according to the embodiment shown in FIG. 1;

FIG. 4 is a partially fragmented sectional view taken along the line 100-100 in FIG. 1;

FIG. 5 is a front elevational view showing the thermal transfer printer according to the embodiment shown in FIG. 1;

FIG. 6 is a plan view showing the thermal transfer printer according to the embodiment shown in FIG. 1;

FIG. 7 is a perspective view showing an infrared communication portion of the thermal transfer printer according to the embodiment shown in FIG. 1;

FIGS. 8 and 9 are plan views for illustrating operations of transmitting and receiving data between the thermal transfer printer according to the embodiment shown in FIG. 1 and the portable telephone;

FIGS. 10 and 11 are side elevational views for illustrating operations of transmitting and receiving data between the thermal transfer printer according to the embodiment shown in FIG. 1 and the portable telephone;

FIG. 12 is a perspective view showing an exemplary conventional thermal transfer printer and a portable telephone having a camera portion and an infrared communication element;

FIG. 13 is a sectional view taken along the line 200-200 in FIG. 12, showing the conventional thermal transfer printer receiving data from the portable telephone;

FIG. 14 is a sectional view taken along the line 200-200 in FIG. 12, showing the conventional thermal transfer printer transmitting data to the portable telephone;

FIG. 15 is a sectional view taken along the line 200-200 in FIG. 12, showing the conventional thermal transfer printer incapable of receiving data from the portable telephone; and

FIG. 16 is a sectional view taken along the line 200-200 in FIG. 12, showing the conventional thermal transfer printer incapable of transmitting data to the portable telephone.

### DESCRIPTION OF THE PREFERRED EMBODIMENTS

An embodiment of the present invention is now described with reference to the drawings.

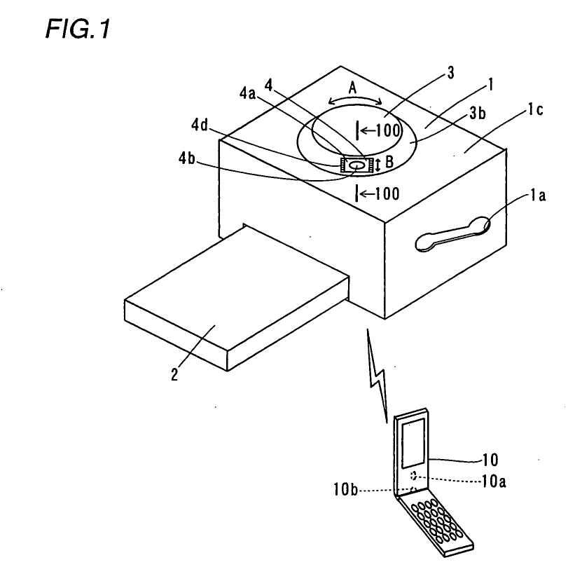

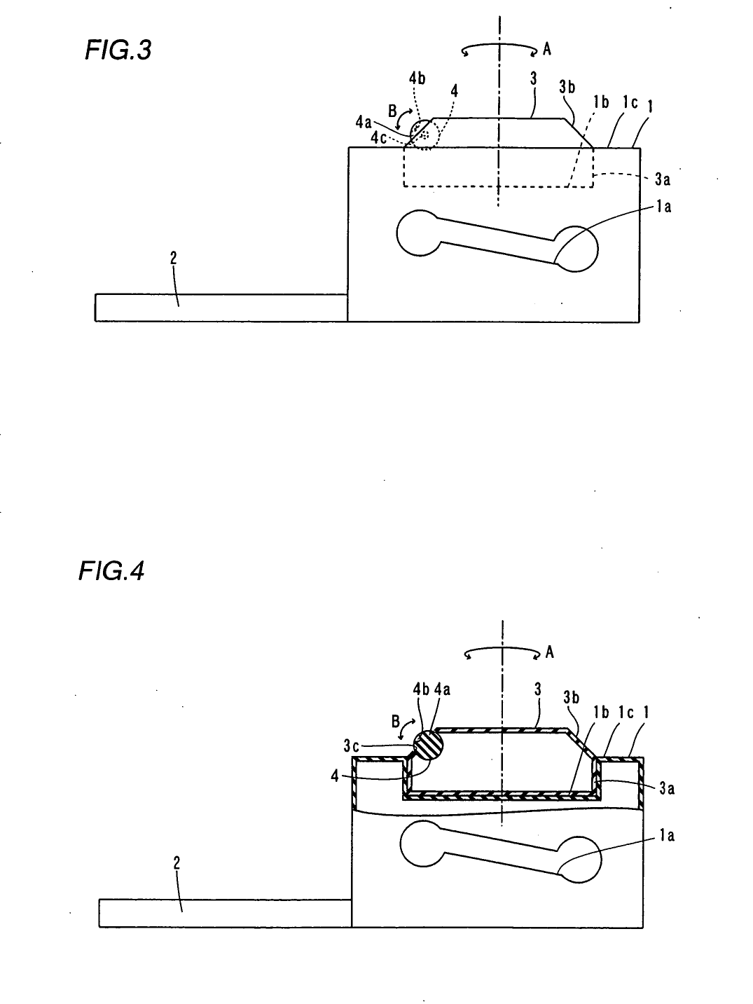

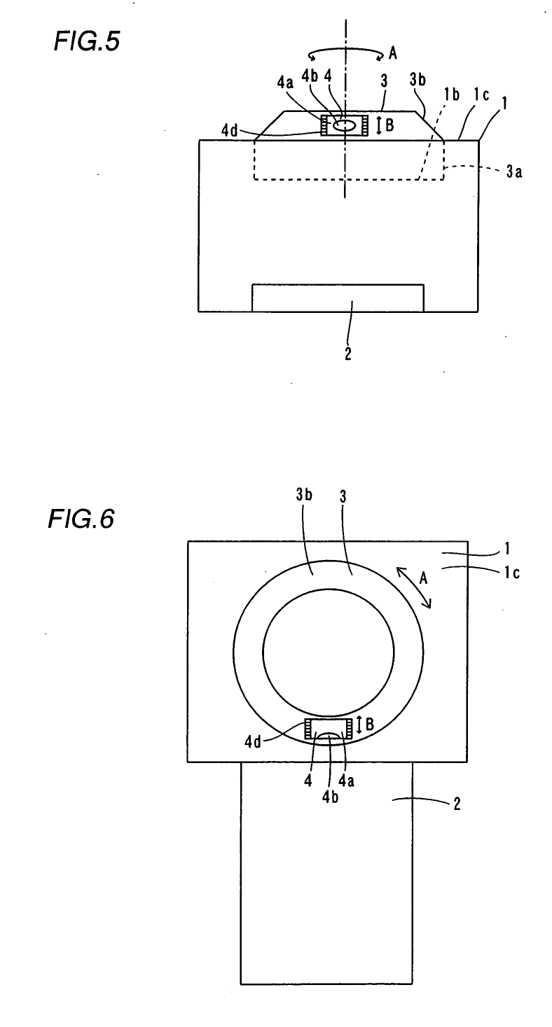

The structure of a thermal transfer printer according to the embodiment of the present invention is described with reference to FIGS. 1 to 7. According to this embodiment, the present invention is applied to the thermal transfer printer, which is an exemplary image generating apparatus.

As shown in FIGS. 1 to 6, the thermal transfer printer according to this embodiment comprises a printer body 1, a paper feed tray 2 detachably mounted on the printer body 1, a rotating member 3 and an infrared communication portion 4 for communication of image data through an infrared signal.

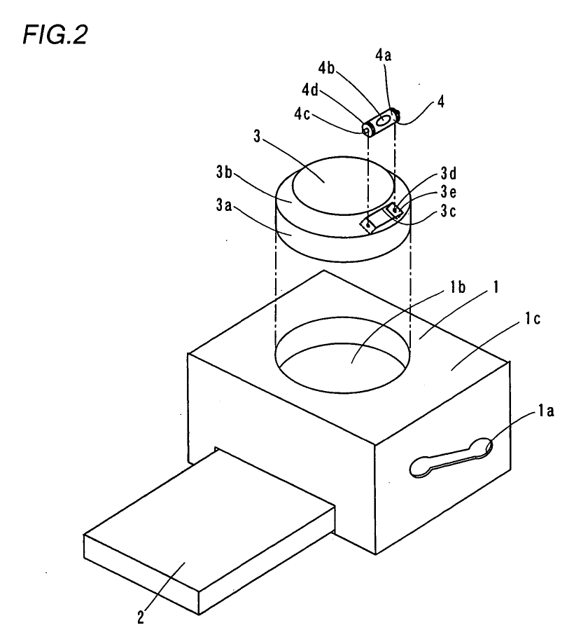

According to this embodiment, the printer body 1 includes a receiving hole la for receiving an ink sheet cartridge (not shown) and a recess portion 1b rotatably holding the rotating member 3, as shown in FIGS. 2 to 4. The recess portion 1b of the printer body 1 is formed on the upper surface 1c of the printer body 1 circularly in plan view. The rotating member 3 is mounted on the printer body 1 to be rotatable by 360° along arrow A, as shown in FIGS. 1 and 3 to 6. This rotating member 3 includes a cylindrical portion 3b stored in the recess portion 1b of the printer body 1 and an infrared communication portion mounting portion 3b exposed outward. The cylindrical portion 3a of the rotating member 3, having a cylindrical form substantially identical in size to the recess portion 1b of the printer body 1 in plan view, is inserted into the recess portion 1b of the printer body 1. Thus, the printer body 1 holds the rotating member 3 in a state rotatable by 360° along arrow A. The infrared communication portion mounting portion 3b of the rotating member 3 provided in addition to the cylindrical portion 3a is inclined at a prescribed angle with respect to the extensional direction of the cylindrical portion 3a. This infrared communication portion mounting portion 3b of the rotating member 3 is provided with an opening 3c for arranging the infrared communication portion 4 therein. A pair of rib portions 3e (see FIG. 2) having engaging holes 3d (see FIG. 2) rotatably holding the infrared communication portion 4 are provided in the vicinity of both longitudinal side surfaces of the opening 3c of the rotating member 3, to inwardly project into the rotating member 3.

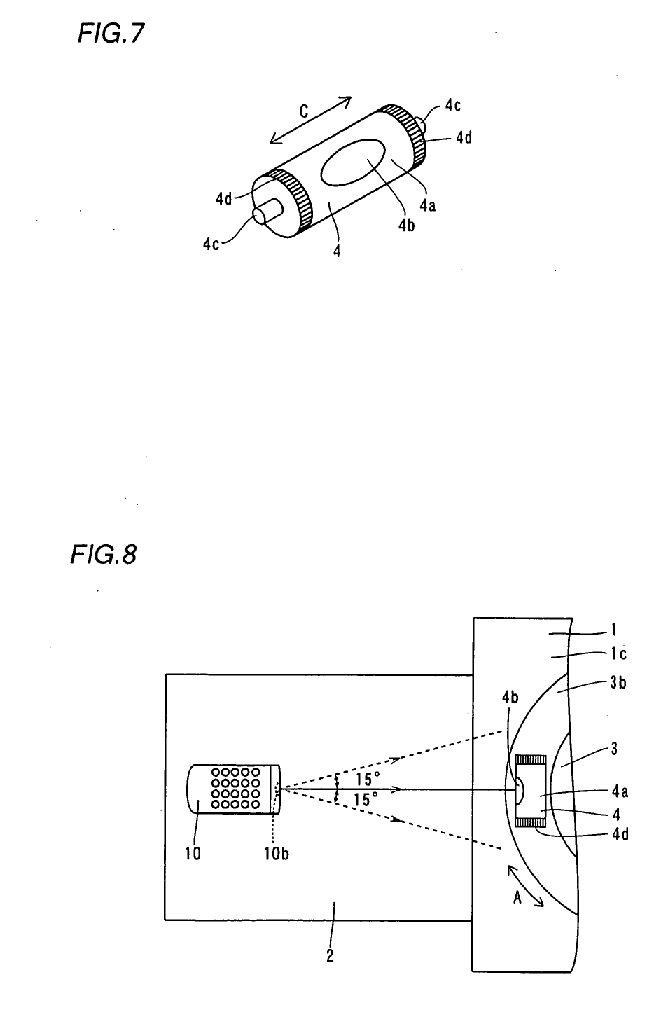

According to this embodiment, the infrared communication portion 4 is mounted on the rotating member 3 to be vertically rotatable (along arrow B), as shown in FIGS. 1 and 3 to 6. This infrared communication portion 4 includes a rotating portion 4a in the form of a column and an infrared communication element 4b, as shown in FIG. 7. The rotating portion 4a of the infrared communication portion 4 includes a pair of shaft portions 4c outwardly projecting along the extensional direction (along arrow C) of the rotating portion 4a respectively. The pair of shaft portions 4c of the infrared communication portion 4 are rotatably inserted into the engaging holes 3d of the rotating member 3 respectively. Thus, the infrared communication portion 4 is mounted on the rotating member 3 to be vertically rotatable (along arrow B) about the shaft portions 4c. Grip portions 4d each having a plurality of projecting portions are provided in the vicinity of both side end surfaces of the rotating portion 4a of the infrared communicating portion 4 respectively at a prescribed interval along the direction of rotation of the infrared communication portion 4.

As shown in FIG. 1, the infrared communication element 4b is so formed as to receive an infrared signal corresponding to image data transmitted from a portable telephone 10, for example, through infrared communication. The portable telephone 10 is an example of the “apparatus” in the present Invention. This portable telephone 10 has a camera portion 10a capable of picking up images and an infrared communication element 10b for transmitting the infrared signal corresponding to data of the images picked up with the camera portion 10a to the thermal transfer printer, as shown in FIG. 1. The camera portion 10a is an example of the “camera function” in the present invention, and the infrared communication element 10b is an example of the “infrared communication function” in the present invention. The infrared communication elements 4b and 10b of the printer body 1 an d the portable telephone 10 correspond to the aforementioned Ir-DA standard. As shown in FIG. 7, the infrared communication element 4b is stored in the rotating portion 4a of the infrared communication portion 4, to expose a communication surface outward. The communicable beam spread angles of the infrared communication elements 4b and 10b of the printer body 1 and the portable telephone 10 are ±15° in the vertical and horizontal directions. The infrared communication element 4b of the thermal transfer printer can receive the infrared signal corresponding to the image data transmitted from the portable telephone 10 through infrared communication, as shown in FIG. 1.

Operations of transmitting/receiving data between the thermal transfer printer according to this embodiment and the portable telephone 10 are now described with reference to FIGS. 8 to 11.

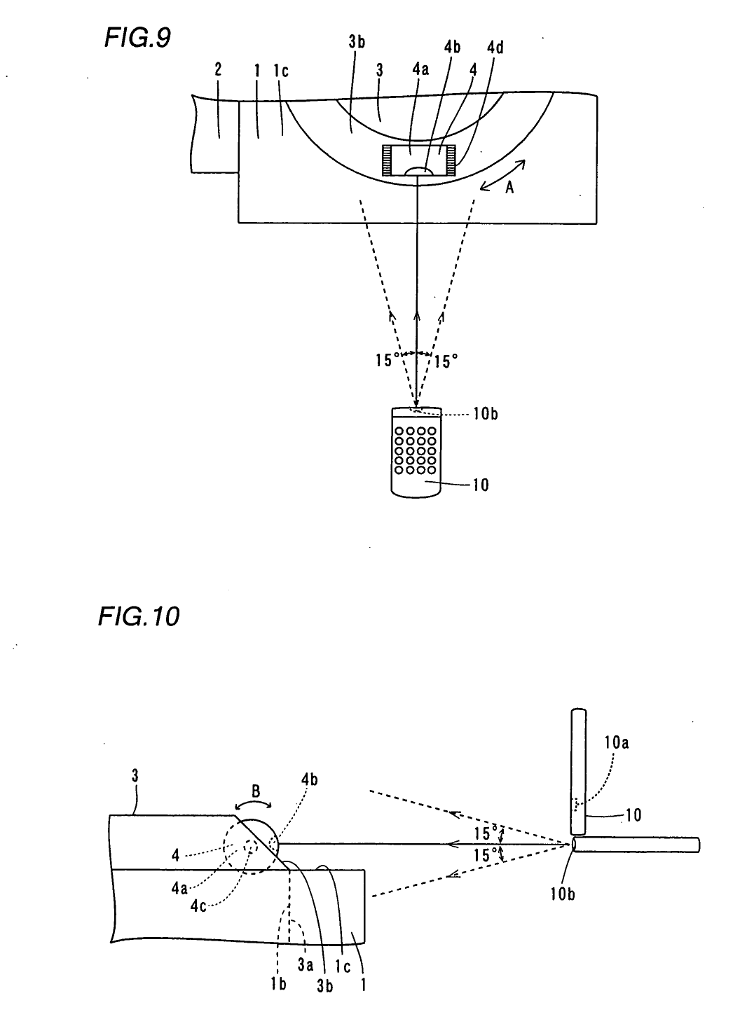

According to this embodiment, the infrared communication element 4b of the printer body 1 may not receive the infrared signal transmitted from the infrared communication element 10b of the portable telephone 10 if the position of the portable telephone 10 horizontally deviates from the infrared communication portion 4 of the printer body 1, since the beam spread angle for receiving the infrared signal introduced into the infrared communication portion 4 of the printer body 1 is ±15°. In this case, therefore, the infrared communication element 4b of the printer body 1 is rotated to a position opposite to the portable telephone 10 by rotating the infrared communication portion 4 of the printer body 1 along arrow A on the upper surface 1c of the printer body 1 along with the rotating member 3, as shown in FIGS. 8 and 9. When the position of the portable telephone 10 horizontally deviates from the infrared communication portion 4 of the printer body 1, therefore, the infrared communication element 4b of the printer body 1 is moved to the position for receiving the infrared signal transmitted from the infrared communication element lob of the portable telephone 10 so that the infrared communication portion 4 of the printer body 1 receives the infrared signal transmitted from the infrared communication element lob of the portable telephone 10.

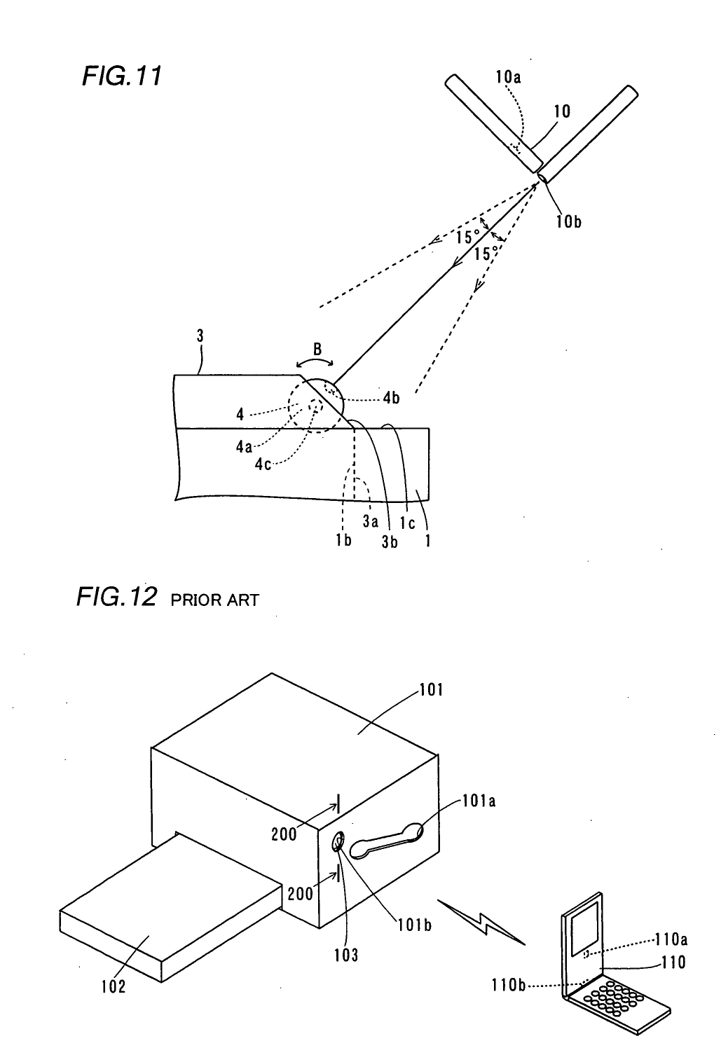

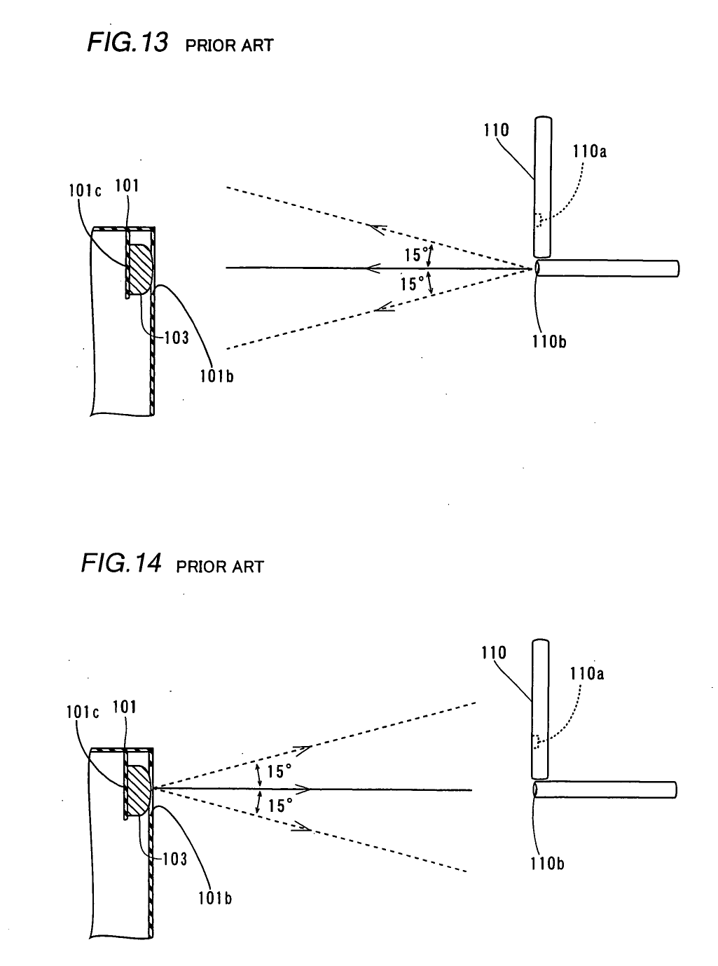

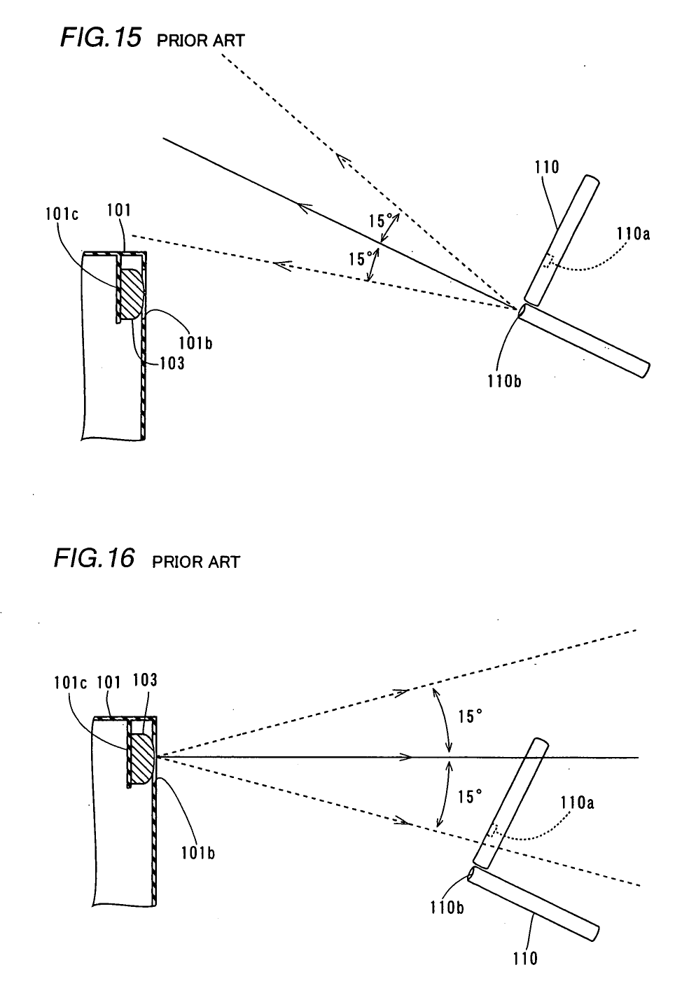

According to this embodiment, further, the infrared communication element 4b of the printer body 1 may not receive the infrared signal transmitted from the infrared communication element lob of the portable telephone 10 if the position of the portable telephone 10 vertically deviates from the infrared communication portion 4 of the printer body 1, since the beam spread angle for receiving the infrared signal introduced into the infrared communication portion 4 of the printer body 1 is ±15°. In this case, therefore, the infrared communication element 4b of the printer body 1 is rotated to another position opposite to the portable telephone 10 by rotating the infrared communication portion 4 of the printer body 1 in the vertical direction (along arrow B), as shown in FIGS. 10 and 11. When the position of the portable telephone 10 vertically deviates from the infrared communication portion 4 of the printer body 1, therefore, the infrared communication element 4b of the printer body 1 is moved to the position for receiving the infrared signal transmitted from the infrared communication element lob of the portable telephone 10 so that the infrared communication portion 4 of the printer body 1 receives the infrared signal transmitted from the infrared communication element 10b of the portable telephone 10.

According to this embodiment, the beam spread direction of an infrared signal transmitted from the infrared communication element 4b of the printer body 1 is changed by rotating the rotating member 3 while rotating the infrared communication portion 4. Thus, the range of the infrared communication element 10b of the portable telephone 10 for receiving the infrared signal is widely changed.

According to this embodiment, as hereinabove described, the thermal transfer printer so comprises the rotating member 3 set on the upper surface 1c of the printer body 1 performing printing to be rotatable along arrow A and the infrared communication portion 4 mounted on the rotating member 3 for infrared communication of image data that the infrared communication portion 4 of the printer body 1 can be rotated to the position opposite to the portable telephone 10 by rotating the infrared communication portion 4 of the printer body 1 on the upper surface 1c of the printer body 1 along arrow A along with the rotating member 3 if the position of the portable telephone 10 horizontally deviates from the infrared communication portion 4 of the printer body 1. Thus, the infrared communication portion 4 of the printer body 1 can receive the infrared signal transmitted from the infrared communication element 10b of the portable telephone 10 also when the position of the portable telephone 10 horizontally deviates from the infrared communication portion 4 of the printer body 1, whereby the thermal transfer printer can perform communication of image data between the same and the portable telephone 10. Consequently, the thermal transfer printer can perform infrared communication over a wide range regardless of the beam spread angle of the infrared communication portion 4 of the printer body 1.

According to this embodiment, the printer body 1 includes the recess portion 1b provided on the upper portion of the printer body 1 circularly in plan view and the rotating member 3 includes the cylindrical portion 3a having a circular shape substantially identical in size to the recess portion 1b of the printer body 1 in plan view so that the recess portion 1b of the printer body 1 stores the cylindrical portion 3a of the rotating member 3, whereby the thermal transfer printer, capable of rotating the rotating member 3 while bringing the cylindrical portion 3a thereof into surface contact with the recess portion 1b of the printer body 1, can suppress backlash when horizontally rotating the rotating member 3 on the printer body 1.

According to this embodiment, the infrared communication portion 4 is mounted on the rotating member 3 to be vertically rotatable (along arrow B) so that the thermal transfer printer can rotate the infrared communication portion 4 of the printer body 1 to the position opposite to the portable telephone 10 by vertically rotating the infrared communication portion 4 of the printer body 1 if the position of the portable telephone 10 vertically deviates from the infrared communication portion 4 of the printer body 1. Thus, the infrared communication portion 4 of the printer body 1 can receive the infrared signal transmitted from the infrared communication element 10b of the portable telephone 10 also when the position of the portable telephone 10 vertically deviates from the infrared communication portion 4 of the printer body 1, whereby the thermal transfer printer can perform communication of image data between the same and the portable telephone 10. Consequently, the thermal transfer printer can perform infrared communication over a wider range regardless of the beam spread angle of the infrared communication portion 4 of the printer body 1.

According to this embodiment, the rotating member 3 further includes the infrared communication portion mounting portion 3b mounted with the infrared communication portion 4 on the printer body 1 in addition to the cylindrical portion 3a and the infrared communication portion mounting portion 3b is inclined at the prescribed angle with respect to the extensional direction of the cylindrical portion 3a of the rotating member 3, whereby the thermal transfer printer can move the infrared communication portion 4 of the printer body 1 to the position opposite to the portable telephone 10 transmitting the infrared signal corresponding to the image data by rotating the infrared communication portion 4 of the printer body 1 toward the uppermost side also when the portable telephone 10 transmitting the infrared signal corresponding to the image data is located immediately above the printer body 1. Thus, the infrared communication portion 4 of the printer body 1 can receive the infrared signal from the portable telephone 10, located immediately above the printer body 1, transmitting the infrared signal corresponding to the image data, whereby the thermal transfer printer can perform infrared communication over a wider range.

According to this embodiment, the infrared communication portion 4 includes the rotating portion 4a mounted on the rotating member 3 to be vertically movable (along arrow B) and the infrared communication element 4b mounted on the rotating portion 4a, whereby the thermal transfer printer can easily move the infrared communication portion 4 in the vertical direction (along arrow B) by rotating the rotating portion 4a in the vertical direction (along arrow B).

According to this embodiment, the rotating portion 4a of the infrared communication portion 4 is so provided in the form of a column that the thermal transfer printer can easily rotate the rotating portion 4a mounted with the infrared communication element 4b in the infrared communication portion mounting portion 3b.

According to this embodiment, the rotating portion 4a in the form of a column is provided on the surface thereof with the grip portions 4d each having the plurality of projecting portions touched by an operator for digitally rotating the rotating portion 4a, whereby the operator can easily move the infrared communication portion 4 in the vertical direction (along arrow B) by digitally rotating either grip portion 4d having the plurality of projecting portions.

According to this embodiment, the grip portions 4b are so provided in the vicinity of both side end surfaces of the rotating portion 4a that the operator can easily vertically move the infrared communication portion 4 by digitally touching the grip portion 4d closer to him/her.

According to this embodiment, the infrared communication portion 4 of the printer body 1 is enabled to receive the infrared signal corresponding to the image data from the portable telephone 10 having the camera portion 10a and the infrared communication element lob transmitting the infrared signal corresponding to the data of the images picked up with the camera portion 10a, whereby the thermal transfer printer can easily fetch the infrared signal corresponding to the data of the images picked up with the camera portion 10a of the portable telephone 10 into the printer body 1 through the infrared communication portion 4 of the printer body 1.

Although the present invention has been described and illustrated in detail, it is clearly understood that the same is by way of illustration and example only and is not to be taken by way of limitation, the spirit and scope of the present invention being limited only by the terms of the appended claims.

For example, the present invention, applied to the thermal transfer printer having the infrared communication portion 4 in the aforementioned embodiment, is not restricted to this but is also applicable to an image generating apparatus other than the thermal transfer printer, so far as the same has an infrared communication portion.

While the above embodiment has been described with reference to the portable telephone 10 employed as an apparatus having the camera portion 10a and the infrared communication element 10b for transmitting image data to the infrared communication portion 4 of the thermal transfer printer, the present invention is not restricted to this but a digital camera having a camera portion and an infrared communication element may alternatively be employed. Further alternatively, the present invention is also applicable to a portable information terminal or a notebook computer having an infrared communication element similar to the infrared communication element 10b.

While the infrared communication portion 4 is vertically movably mounted on the rotatable member 3 in the aforementioned embodiment, the present invention is not restricted to this but the infrared communication element 4b may alternatively be provided on the rotating member 3 formed in a vertically rotatable manner.

While the infrared communication portion 4 is in the form of a column in the aforementioned embodiment, the present invention is not restricted to this but the infrared communication portion 4 may alternatively be in the form of a sphere.

While the grip portions 4d each having the plurality of projecting portions are formed in the vicinity of both side end surfaces of the rotating portion 4b of the infrared communication portion 4 in the aforementioned embodiment, the present invention is not restricted to this but a grip portion 4d may alternatively be formed only in the vicinity of one side end surface of the rotating portion 4b of the infrared communication portion 4.

What is claimed is:

1. An image generating apparatus comprising:
a rotating member horizontally rotatably set on the upper surface of an apparatus body performing printing; and
an infrared communication portion mounted on said rotating member for infrared communication of image data.

2. The image generating apparatus according to claim 1, wherein
said apparatus body includes a recess portion provided on an upper portion of said apparatus body circularly in plan view,
said rotating member includes a cylindrical portion having a circular shape substantially identical in size to said recess portion of said apparatus body in plan view, and
said recess portion of said apparatus body stores said cylindrical portion of said rotating member.

3. The image generating apparatus according to claim 1, wherein
said infrared communication portion is vertically rotatably mounted on said rotating member.

4. The image generating apparatus according to claim 3, wherein
said rotating member further includes an infrared communication portion mounting portion mounted with said infrared communication portion in addition to said cylindrical portion, and
said infrared communication portion mounting portion is inclined at a prescribed angle with respect to the extensional direction of said cylindrical portion of said rotating member.

5. The image generating apparatus according to claim 3, wherein
said infrared communication portion includes a rotating portion vertically rotatably mounted on said rotating member and an infrared communication element mounted on said rotating portion.

6. The image generating apparatus according to claim 5, wherein
said rotating portion of said infrared communication portion is in the form of a column.

7. The image generating apparatus according to claim 5, wherein
said rotating portion is provided on the surface thereof with a corrugated grip portion touched by an operator for digitally rotating said rotating portion.

8. The image generating apparatus according to claim 7, wherein
said grip portion is provided in the vicinity of each side end surface of said rotating portion.

9. The image generating apparatus according to claim 1, wherein
said infrared communication portion of said apparatus body is capable of receiving an infrared signal corresponding to image data from an apparatus having a camera function and an infrared communication function of transmitting said infrared signal corresponding to said image data picked up through said camera function.

10. The image generating apparatus according to claim 1, wherein
said infrared communication portion of said apparatus body is so formed as to perform infrared communication employing the Ir-DA standard having a prescribed beam spread angle.

11. An image generating apparatus comprising:
an infrared communication portion set on an apparatus body performing printing for infrared communication of image data; and
a rotating member horizontally rotatably set on the upper surface of said apparatus body performing printing, wherein
said infrared communication portion of said apparatus body includes a rotating portion vertically rotatably mounted on said rotating member and an infrared communication element mounted on said rotating portion and is capable of receiving an infrared signal corresponding to image data from an apparatus having a camera function and an infrared communication function of transmitting said infrared signal corresponding to said image data picked up through said camera function, and
said rotating portion is provided on the surface thereof with a corrugated grip portion touched by an operator for digitally rotating said rotating portion.

12. The image generating apparatus according to claim 11, wherein
said apparatus body includes a recess portion provided on an upper portion of said apparatus body circularly in plan view,
said rotating member includes a cylindrical portion having a circular shape substantially identical in size to said recess portion of said apparatus body in plan view, and
said recess portion of said apparatus body stores said cylindrical portion of said rotating member.

13. The image generating apparatus according to claim 11, wherein
said rotating member further includes an infrared communication portion mounting portion mounted with said infrared communication portion in addition to said cylindrical portion, and
said infrared communication portion mounting portion is inclined at a prescribed angle with respect to the extensional direction of said cylindrical portion of said rotating member.

14. The image generating apparatus according to claim 11, wherein
said rotating portion of said infrared communication portion is in the form of a column.

15. The image generating apparatus according to claim 11, wherein
said grip portion is provided in the vicinity of each side end surface of said rotating portion.

16. The image generating apparatus according to claim 11, wherein
said infrared communication portion of said apparatus body is so formed as to perform infrared communication employing the Ir-DA standard having a prescribed beam spread angle.
